(19) United States
(12) Patent Application Publication
(10) Pub. No.: US 2007/0010207 A1
(43) Pub. Date: Jan. 11, 2007

(54) System and method for the ultra-precise analysis and characterization of RF propagation dynamics in wireless communication networks

(76) Inventor: John Aldrich Dooley, East Marion, NY (US)

Correspondence Address: John A. Dooley, P.O. Box 161, East Marion, NY, 11939, US

(21) Appl. No.: 11/174,817

(22) Filed: Jul. 5, 2005

(51) Int. Cl. H04B 17/00; H04Q 7/20

(52) U.S. Cl. 455/67.11; 455/424

(57) ABSTRACT

The present invention relates to a system and method for the ultra-precise analysis and characterization of RF propagation dynamics in complex wireless communication networks. The invented system includes sub-systems for the collection of network specific performance and environmental data, the consolidation of said data into representative signature elements, and the organization of said signature elements into a relational matrix. Through the invented methodology, RF performance and environmental composition data are closely correlated in uniformly weighted signature elements. These signatures, arranged in a relational matrix, represent a multiplicity of propagation pattern extrema. Limited RF data is compiled and formed into fractional signature elements. Fuzzy logic based reconstructive techniques are used to integrate these fractional elements into the normal signature matrix, allowing rapidly gathered and severely abbreviated data to produce extremely detailed and accurate characterization of RF propagation in localized coverage zones.

### BACKGROUND OF THE INVENTION

1. Field of the Invention:

The present invention relates generally to the field of wireless electronic communications. In particular, the present invention pertains to a means and technique for predicting and characterizing the RF propagation dynamics of wireless networks operating in complex signal environments (e.g. urban cellular voice/data communications systems).

2. Description of the Related Art:

Recent years have seen dramatic growth in both the scope and complexity of wireless network applications. Whereas mobile connectivity was once a costly luxury enjoyed by a privileged few, it has now become a ubiquitous necessity that readily crosses demographic boundaries. Throughout every part of the developed world, wireless networks are increasingly displacing landline usage, while achieving near-universal subscribership.

This fundamental shift in the dynamics of the wireless marketplace has had a significant impact on large-scale mobile network design considerations. Originally conceived of as an ancillary extension of the PSTN (Public Switched Telephone Network), wireless has been increasingly called upon to become a primary communications medium that offers a compelling approximation of the landline communications experience. Thus, as landline communications have come to include both voice and broadband data services, wireless networks have had to make many of the same advanced applications a part of their next-generation service offerings.

Despite significant commercial imperatives, achieving reliable broadband connectivity in the mobile environment has become a process complicated by considerable engineering challenges. While the extension of large-scale data connectivity in wireline systems is largely a matter of logistics, the integration of high-speed data into mobile network infrastructure requires that network developers surmount several key technological barriers relating to both signal coverage and bandwidth capacity. Whereas properly designed wireline networks can expect virtually unlimited signal reliability and bandwidth scalability, wireless systems are limited by both finite spectral resources and an inherently unpredictable transmission medium.

Early on in the development of the first public analog voice networks, it was determined that the wireless medium needed to be controlled in new ways. In order to reliably service an increasing number of subscribers with a finite number of frequencies, networks needed methods to ensure adequate signal coverage while continuously recycling scarce spectral resources. The solution was the now commonly used process of cellularization. In theory, cellular-based system design gives wireless networks a level of long-term application bandwidth and subscribership scalability that would not otherwise be feasible. Through the deployment of cellular-based design methodologies, system capacity can be effectively multiplied by significant factors throughout the lifecycle of a given mobile network.

Cellularization is founded upon the concept of frequency re-use. In a cellular-based network, the overall coverage zone is divided into a discrete number of smaller sub-zones or “cells.” Typically, the network's entire frequency allocation is distributed within a small group of interlocking cells, commonly called a “cell cluster.” This cell cluster is in turn interlocked with a large collection of adjacent cell clusters, which collectively cover the network's entire area of operation. By carefully segregating portions of the overall frequency allocation within each cell cluster, cell-based network design principles allow relatively small amounts of RF (radio frequency) spectrum to be continuously recycled within a given geographic region.

A highly beneficial quality inherent to cellular-based networking is that of upward bandwidth scalability. As requirements for per-user bandwidth and overall system capacity grow, the size of existing cells and cell clusters can be reduced in effective area. This allows for both the addition of new cells and the increase in overall cellularization density. Smaller and more numerous cell clusters permit spectrum to be recycled more frequently and over progressively shorter geographic distances. Thus, in theory, cell-based design principles provide network developers with a means of linearly adapting infrastructure to meet expansion in application bandwidth requirements and overall subscriber loading.

Unfortunately, however, practical cellular networking seldom displays the ease of scalability demonstrated in theory. This is especially true in urbanized environments, where the complexity of the RF propagation medium confounds attempts at precision cell formation and scaling. Plagued by a broad diversity of reflective, refractive, diffractive and absorptive phenomena, urban and semi-urban environments are naturally limited in their ability to accommodate highly scalable cellularization practices. Such limitations stand as fundamental barriers to network expansion. This is because urbanized coverage zones, with their overwhelmingly dense concentration of network traffic, are the places where efficient cellularization is most necessary.

The prime enabler of cell-based network development is RF propagation analysis and characterization technology. A fundamental pre-requisite to the formation of individual cell coverage zones and clusters, analysis and characterization of propagation dynamics in the mobile environment allows engineers to establish appropriately confined and interlocking cell zone geometries. Therefore, the maximum cellularization potential of a given network is directly proportional to the highest achievable resolution of available propagation prediction technology. With each expansion in cell cluster density must come a complementary increase in the effective resolution and accuracy of predictive capabilities.

Among the various propagation analysis methodologies that constitute the prior art, nearly all rely heavily on data derived from a combination of statistically based predictive algorithms and extensive in-situ field measurements. Experimentally derived values are used to modify standard free-space RF path loss formulae in ways that mimic the eccentricities generated by variability in the local wireless medium. Using a selection of these statistically based modifiers, engineers can calculate RF performance characteristics in a limited number of generic environmental types (i.e. rural, sub-urban, urban, etc.). Modified free space loss calculations are then used to project probable cell-zone coverage patterns, which are typically-displayed using-geo-spatial mapping software. Finally, these projections are combined with actual field measurements that either complete the analysis or assist in refinement of the statistical projection tool (i.e. aid in the selection of a more appropriate predictive algorithm).

While adequate for early analog networks, the systems and methodologies of the prior art are incapable of coping with the complexities of current and anticipated high-density digital applications. This is because the minimum resolution accuracy of conventional statistical/field testing technologies is insufficient to reliably achieve cellularization planning at the miniaturized scales needed to convert finite spectrum into a stable broadband resource. Thus, deficiencies in the prior art clearly call for new inventions that substantially exceed the resolution, accuracy and overall efficiency of existing RF propagation analysis and characterization technology.

### BRIEF SUMMARY OF THE INVENTION

The object of the present invention is to provide a means by which the RF propagation dynamics of complex mobile network environments can be predicted and analyzed with extremely high levels of resolution, accuracy and efficiency. Said invention allows for the surmounting of key technological barriers faced by the prior art, relating to insufficient propagation analysis capabilities in support of wireless network planning and operation.

The utility of the invented system is achieved through use of novel RF environmental data collection, reconstruction and analysis methodologies. These methodologies are reflected in three aspects of the present invention: 1) the micro-scale characterization of network propagation; 2) the rapid micro-scale characterization of network propagation; 3) the projection of network propagation parameters using micro-scale propagation characterization.

In a first aspect of the present invention, a system and methodology is given for the micro-scale characterization of RF propagation phenomena in complex network environments. Comprehensive RF environmental data 101 is collected from a multiplicity of sources, and then uniformly weighted and normalized 102 using an experimentally derived rules engine. Once appropriately weighted and normalized 102, this RF data 101 is segregated by functional coherence and compiled into unique signatures 103 that represent a comprehensive assay of propagation characteristics within a single micro-scale region of the coverage environment. Finally, these signatures 103 are assembled into a matrix 104 of complementary signatures, which collectively represent of a broad continuum of propagation characteristic extrema.

In a second aspect of the present invention, a system and methodology is given for the highly rapid micro-scale characterization of RF propagation phenomena in complex network environments. Here, severely abbreviated RF environmental data is collected from a single source 105, and then appropriately weighted and normalized 106 using elements of the same rules employed in the complete signature creation process. Once weighted and normalized 106, abbreviated RF data 105 is segregated by functional coherence and compiled into a fractional signature element 107. This fractional signature is then compared to a large body of complete signatures in an already established signature matrix 108. Through the use of fuzzy logic derived techniques, the missing elements of the fractional signature are effectively reconstructed 109, resulting in a complete RF environmental characterization signature 110 similar in depth and accuracy to those created with a multiplicity of sources. This allows for the extremely comprehensive characterization of micro-scale RF phenomena using small amounts of rapidly acquired data.

In a third and final aspect of the present invention, a system and methodology is given for the identification and projection of network propagation parameters using micro-scale propagation characterization. Employing the rapid micro-scale characterization methodology outlined in the second aspect of this invention, highly specific RF propagation parameters are identified for small sub-zones of the overall wireless coverage area. Once identified, these propagation parameters are further refined and correlated with extremely detailed geo-spatial models of the individual coverage zone. Using experimentally derived free space RF injection models, the micro-scale characterization capabilities made possible by the invented system allow for efficient projection of propagation 111 with resolution accuracies exceeding ten wavelengths at commonly used commercial cellular voice/data network frequencies. Finally, error correction processes 112 are applied that compare automated field measurements with signature-based propagation projections for the purposes of refining both signatures and weighting/normalization rules applied to the entire signature matrix.

In sum, the principles of the present invention allow for the establishment of RF propagation parameter characterization, identification and projection with resolution and accuracy at least one order of magnitude greater than that achieved via systems and methodologies in the prior art. Specifically, the disclosed system creates increased utility for the field of cellular-based broadband wireless communication systems by providing for extremely detailed analysis and projection of propagation dynamics for existing and hypothetical RF systems operating in complex urban/semi-urban environments. Such levels of analysis and projection are universally regarded as fundamental prerequisites to achieving the bandwidth scalability and QoS (Quality of Service) called for by next-generation mobile internetworking applications.

The foregoing has outlined rather broadly the features and technical advantages of the present invention in order that the detailed description of said invention that follows may be better understood. Additional features and advantages of the invention will be described hereinafter, which will form the subject of the claims of the invention. It should be appreciated by those skilled in the art that the conception and the specific embodiment disclosed may be readily utilized as a basis for modifying or designing other structures for carrying out the same purposes as the present invention. It should also be realized by those skilled in the art that such equivalent constructions do not depart from the spirit and scope of the invention as set fourth in the appended claims.

### BRIEF DESCRIPTION OF THE DRAWINGS

FIG. 1 is an overview of a preferred embodiment of the invented system.

FIG. 2 is a diagram of RF environmental signature creation.

FIG. 3 is a diagram of signature placement into the signature matrix.

FIG. 4 is a diagram of fractional data collection, weighting and signature creation.

FIG. 5 is a diagram of provisional placement of a fractional signature into the matrix.

FIG. 6 is a diagram of fuzzy logic-based fractional signature reconstruction.

FIG. 7 is a diagram of RF propagation pattern identification and projection.

FIGS. 8A and 8B are diagrams illustrating the error correction methodology.

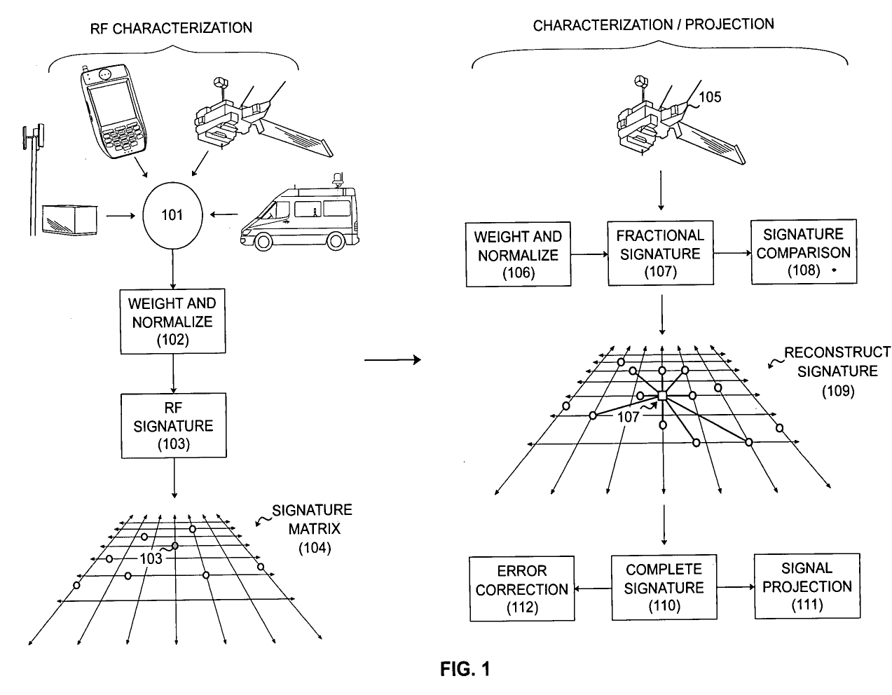

### DETAILED DESCRIPTION OF A PREFERRED EMBODIMENT OF THE INVENTION

A first aspect of the present invention provides for the high-resolution micro-scale characterization of RF propagation dynamics in selected sub-regions of the overall coverage zone. This aspect of the invented system and methodology allows a diversity of RF environmental data sources to be combined into a single RF environmental signature, which is universally compatible with other such signatures for the purposes of detailed propagation performance characterization, identification and comparison. Complete and universally compatible RF environmental signatures can then be arranged into a matrix of signatures, which collectively represent a continuum of RF propagation characteristic extrema (i.e. ranging from rural-type to urban-type propagation parameters). The resulting signature matrix can be utilized for processes reflected in additional aspects of the present invention including: a) the rapid creation of complete RF environmental signatures from partial data; b) the rapid identification of propagation characteristics for sub-regions of the overall coverage zone; c) the high-resolution/high accuracy projection of propagation characteristics for sub-regions of the overall coverage zone.

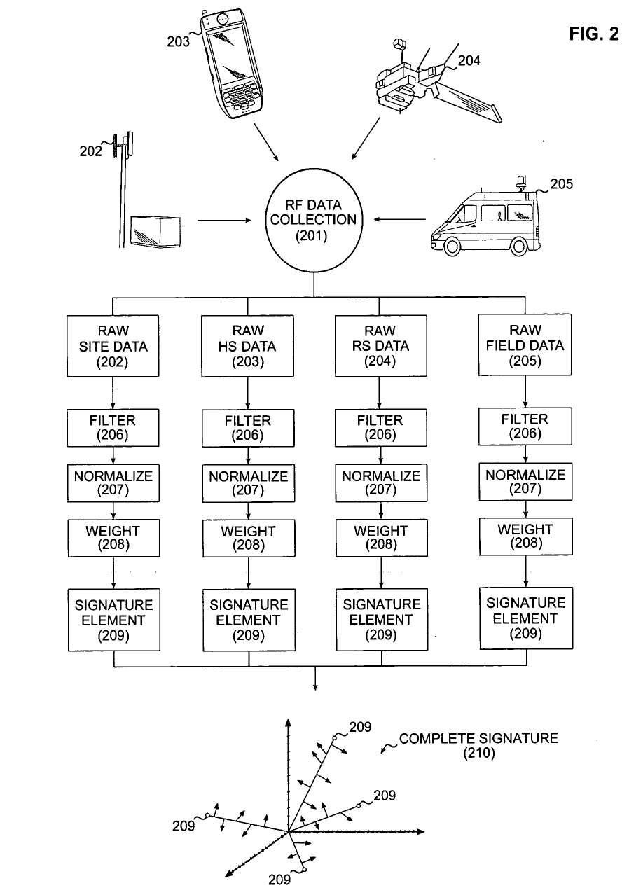

FIG. 2 is a diagram representing the invented RF environmental signature creation process. Signature creation is begun through the collection of highly detailed RF data 201 that reflects many aspects of the local operational environment. This data includes, but is not limited to: high-resolution multi-spectral remote sensing imagery 204 of the coverage zone, detailed handset reporting 203 of signal to noise ratio and bit error rate within the coverage zone, detailed cell site reporting 202 of signal to noise ratio and bit error rate within the coverage zone, and drive-test acquired field component continuity measurements 205 taken within the coverage zone.

Once collected, the multiplicity of assembled RF data is normalized 207 into a single and inter-compatible data format, using common digital data analysis techniques well known to the prior art. Normalized data remains segregated by its source and is then further refined through the use of filtration 206 that eliminates noise products and other contaminates inherent to each individual data type and collection process. After appropriate normalization 207 and filtration 206, the resulting data sets from each RF environmental analysis source can be considered sufficiently lean, free of irrelevant or spurious components, and completely compatible with one another.

When adequately normalized 207 and filtered 206, the data from each disparate RF environmental analysis source is weighted 208 individually by its importance, relative to the other sources, in creating an accurate and comprehensive assay of highly localized RF propagation conditions. For example, normalized and filtered data from multi-spectral remote sensing imagery 204 may be given a significantly higher weighting than signal to noise ratio data from handsets 203 in the coverage environment, which, in turn, may be given a slightly higher weighting than bit error rate data from cell site base stations 202. In practical implementation of preferred embodiments, the relative weighting of data from diverse RF environmental observations is determined experimentally and continuously refined throughout the life of the analysis system.

Having been filtered 206 for spurious noise, normalized 207 for cross-compatibility, and selectively weighted 208 to assure appropriate relevance of component data, the information from each RF environmental data source is compiled into a discrete signature element 209. In preferred embodiments of the present invention, the broad diversity of data contained in each element 209 is translated to and stored as an n-dimensional vector space. These discrete signature elements are then collectively compiled into a single RF environmental characterization signature 210, which is also expressed as an n-dimensional vector space. The rules governing the geometric arrangement of signature elements within said signature are kept constant so that the signature will have a linear relationship with other signatures containing RF coverage data collected in diverse environment types. This signature 210 can be considered as a highly detailed characterization of all RF propagation parameters within the micro-scale sub-region of the overall coverage zone from where its component data was collected. The size and configuration of the geographic area represented by each RF environmental signature 210 are variable and independent quantities.

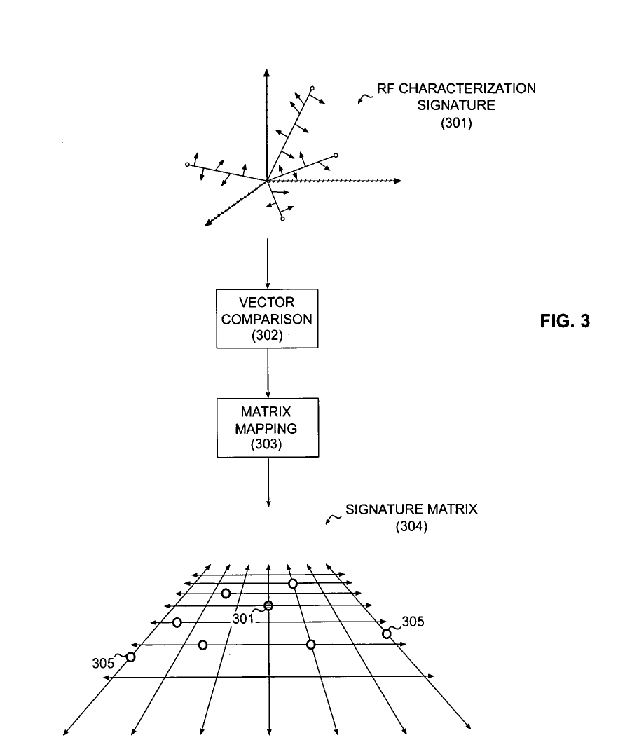

Once a critical mass of discrete environmental signatures has been collected for a variety of RF environmental types (i.e. urban, semi-urban, rural), said signatures are arranged into a “signature matrix.” Shown in FIG. 3 is a signature matrix 304 containing a broad continuum of RF environmental characterization signatures 305, with each signature reflecting a point of highly detailed RF environmental characterization placed linearly upon the complete range of RF environmental extrema. New RF characterization signatures 301 created in the previously described method are compared 302 with the existing body of signatures 305 already in the matrix 304. This vector comparison 302 effectively defines the relationship between the detailed propagation performance characteristics of the new RF environmental signature 301 and those represented by its previously collected counterparts. This relationship is a linear one, spanning the full spectrum of propagation characteristic extrema. Vector comparison between signatures allows for the appropriate mapping 303 and placement of the new characterization signature within the matrix 304. The signature matrix 304 is left open, allowing additional signatures 305 to populate it over time, while also permitting the configuration of each signature (normalization rules, weighting, etc.) to be dynamically adjusted.

A second aspect of the present invention provides for rapid high-resolution micro-scale characterization of RF propagation dynamics in selected sub-regions of the overall coverage zone. This aspect of the invented system and methodology allows severely abbreviated RF environmental data collection to be normalized and weighted using the same rules derived from the first aspect of the invention. Once processed, the abbreviated data can be formed into a fractional signature that is compared to completed signatures already in the established signature matrix. Specially adapted fuzzy logic processes can then be employed to reconstruct the fractional signature into a complete RF environmental signature. This allows extremely minimal amounts of RF environmental data to produce highly accurate micro-scale propagation characterizations, which can be utilized for both propagation pattern prediction and expansion of the signature matrix.

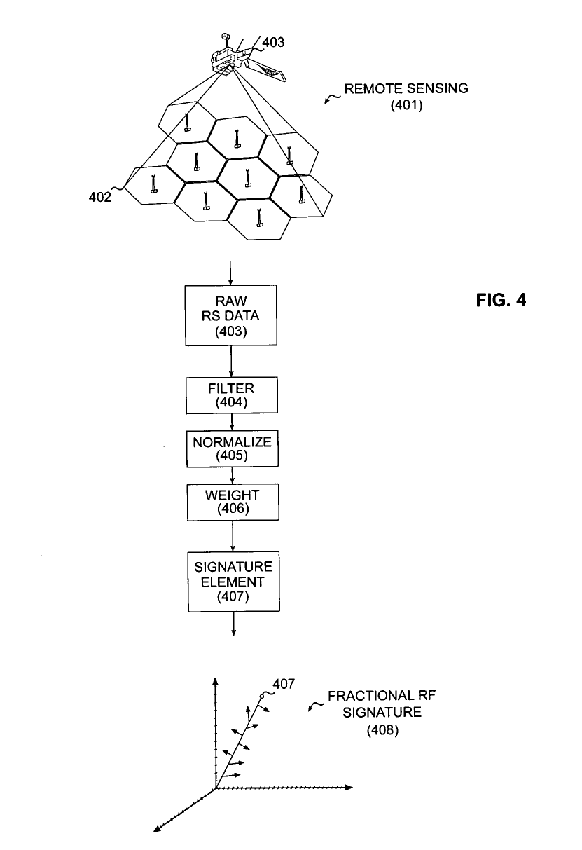

FIG. 4 is a diagram depicting fractional data collection, weighting and signature creation. The rapid micro-scale characterization methodology is begun with a severely abbreviated data collection process. In this aspect, the multiplicity of RF environmental data sources used to create a complete characterization signature (multi-spectral remote sensing imagery, field component continuity measurements, handset reporting, site reporting, etc.) is replaced by a single, robust and easily collectible set of data. In preferred embodiments, this single source of data is typically that resulting from filtering and normalization of medium to high-resolution multi-spectral remote sensing 401, which is derived primarily from satellite imagery 403.

The remote sensing data 403 covering a given sub-region of the overall coverage zone 402 is processed as if it were paired with its typical complement of additional RF survey data. The single source data undergoes filtration 404, normalization 405 and weighting 406 to produce a discrete signature element 407. This element 407 is then integrated into a signature using the same n-dimensional vector space configuration as the conventional multiple data source signatures. This results in a RF environmental characterization signature 408 that has similar structure and cross-compatibility with conventional multiple source signatures, but is incomplete or “fractional.” Such a fractional signature 408 becomes the first step in rapid characterization of the sub-region.

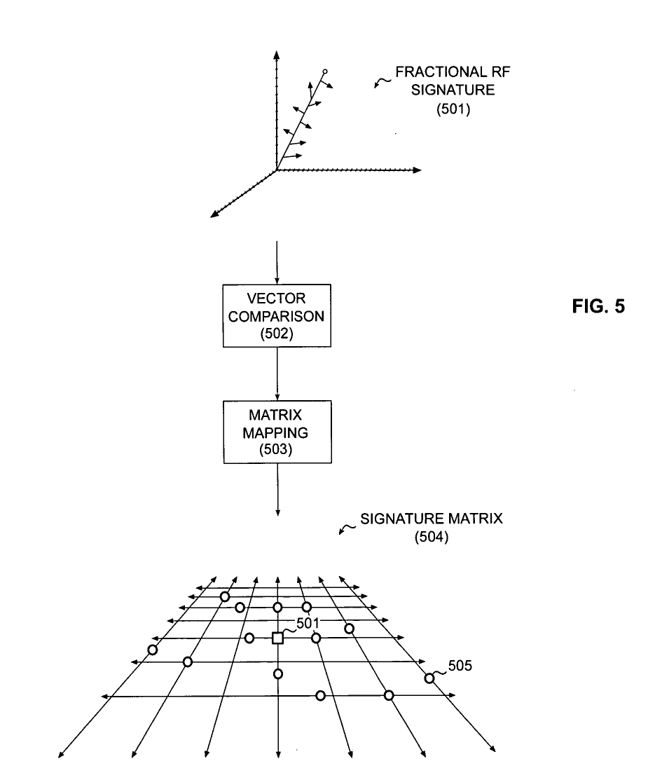

Once a sufficient quantity of complete RF environmental classification signatures has been compiled and integrated into a signature matrix as described in the first aspect of the preferred embodiment, fractional signatures created with very limited data can be effectively reconstructed. FIG. 5 illustrates this process.

A fractional signature 501 created with limited data is compared 502 to the collection of complete signatures in the matrix, which represent a continuum of RF environment types. Using the same vector comparison 502 and mapping 503 techniques employed for the complete signatures, the fractional signature 501 is then placed in a position within the matrix 504 that reflects its relative relation to the performance characteristics of the completed signatures 505 already there. As all the signatures, both complete and fractional have been filtered, normalized and weighted using the same rules, comparing the limited elements in a fractional signature 501 to corresponding elements in a complete signature 505 is an uncomplicated process of geometric summation and averaging of the given data. The resulting product is an extremely rapid general identification of propagation characteristics for a given sub-region of the overall coverage zone, which effectively allows miniscule quantities of environmental data to readily generate a comparative analysis of localized RF propagation parameters.

However, this placement of a fractional signature within the signature matrix is only an initial step in reconstruction of a complete signature. Comparing existing elements of a fractional signature with corresponding data in a complete signature allows for a high-confidence relational analysis between the unknown general propagation characteristics associated with the fractional signature and the extremely comprehensive and well known characteristics of the complete signatures. Simple relational analysis sets up a coordinate system within the matrix, in which the relative position of the fractional signature defines its relationship or similarity to the adjacent completed signatures.

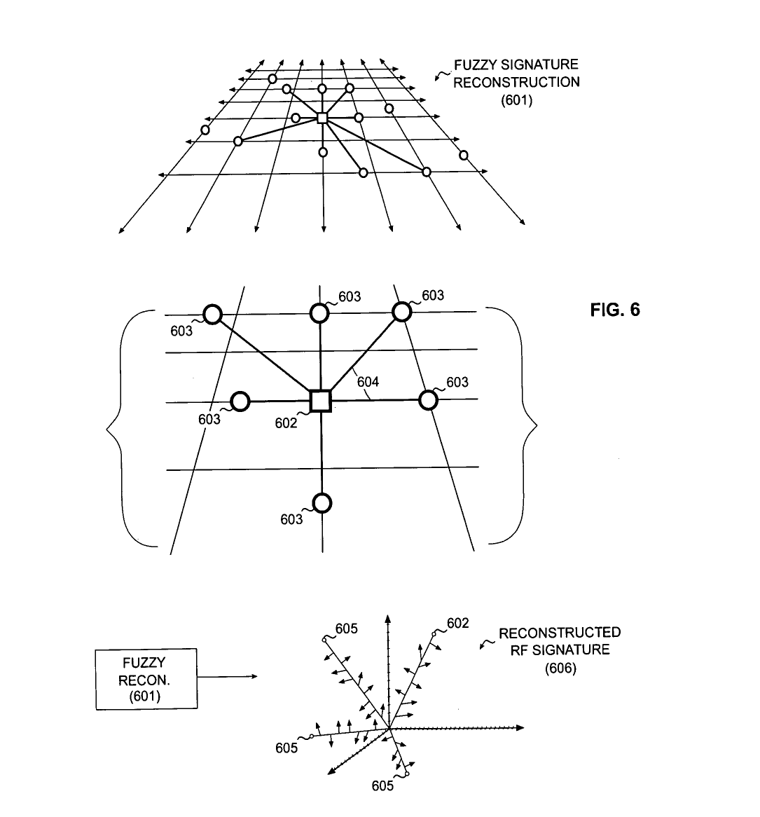

FIG. 6 illustrates the signature reconstruction process. Once the coordinate position of the fractional signature 602 relative to a sufficient number of completed characterization signatures 603 has been established within the matrix, any of a number of fuzzy logic processes 601 known to the art are then utilized to construct a complete signature 606 from the original fractional element 602. Using the relative separation 604 between the fractional signature 602 and its nearby complete counterparts 603, fuzzy logic processes 601 determine the degree to which the incomplete signature shares similar characteristics to its neighbors. In accordance with the proportional differences between the fractional and complete signatures, the missing data components can be readily computed. The result is a complete signature 606 that emerges from the minimal and incomplete data.

Reconstructed fractional signatures are considered high-confidence portrayals of the coverage zone sub-region from which their limited data originally emerged. Therefore, post-reconstruction, these now complete signatures are integrated into the signature matrix in a manner identical to that of signatures created with complete data as described in a first aspect of the invented system. In this way, the fractional signature approach is utilized for not only rapid characterization of individual portions of the RF environment, but also for efficient expansion of the signature matrix. It will be seen by those skilled in the art that a progressively larger signature matrix will yield correspondingly faster and more accurate classification and reconstruction of fractional signatures. This, in turn, will yield a progressively greater capacity to characterize and project RF propagation parameters with increasing confidence and on decreasing scales of distance within cellular coverage zones.

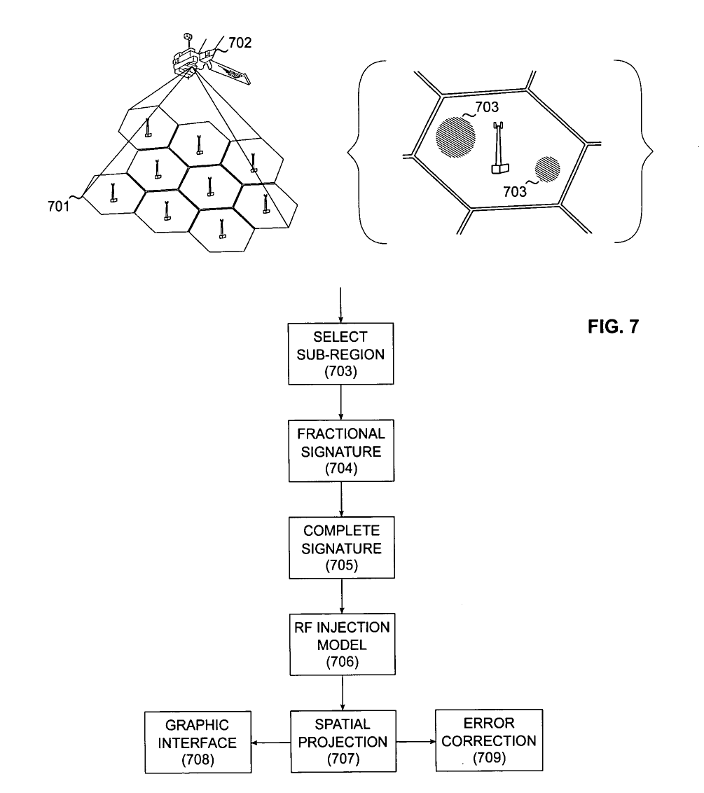

A third aspect of the present invention provides for the efficient and highly accurate identification and projection of RF propagation parameters using the micro-scale characterization data created via previous aspects of the invented system and methodology. FIG. 7 illustrates this process.

First, a geographic area of interest 701 is defined for the projection of RF propagation parameters. Then, remote sensing 702 is used to determine areas of structural similarity 703 (e.g. areas of similar RF reflective, refractive and diffractive properties), which effectively define the size and shape of coverage zone sub-regions. Following this, detailed RF performance characteristics are identified for each sub-region and reconstructed using limited remote sensing data 702 in a method similar to that outlined in a second aspect of the present invention. This process is completed for a given sub-region of the coverage zone, as well as any number of adjacent sub-regions covering the overall geographic area of interest 701.

Once the requisite number of rapid characterization fractional signatures 704 have been collected and reconstructed into complete signatures 705, these completed signatures are used to produce RF injection models 706 for each sub-region 703 or portion of each sub-region within the overall coverage zone. Said RF injection models use the extremely comprehensive localized RF environmental parameters contained within each signature to project signal propagation characteristics for a given sub-region. These signature assisted injection models 706 are then correlated with spatial projection data 707 of the coverage environment to produce visual three-dimensional maps of signal propagation that can be viewed and manipulated by network engineers via a graphic interface 708. The resolution and accuracy of these signal propagation maps is determined by the number of signatures in the original matrix, the relative size of each sub-region as defined by the remote sensing analysis, and the relative complexity of the local spatial environment.

The accuracy of RF propagation prediction and projection is ensured through the use of error correction techniques 709. Data collected from handset and site reporting is continuously compared to the projections made based on RF environmental signature data. This process can be used to detect anomalous individual signatures or to determine if there are broad errors in the general normalization and weighting rules applied to all signatures. Individual signatures are corrected or expunged, while broad errors spanning the entire signature matrix are collectively repaired by refinement of the general normalization and weighting rules.

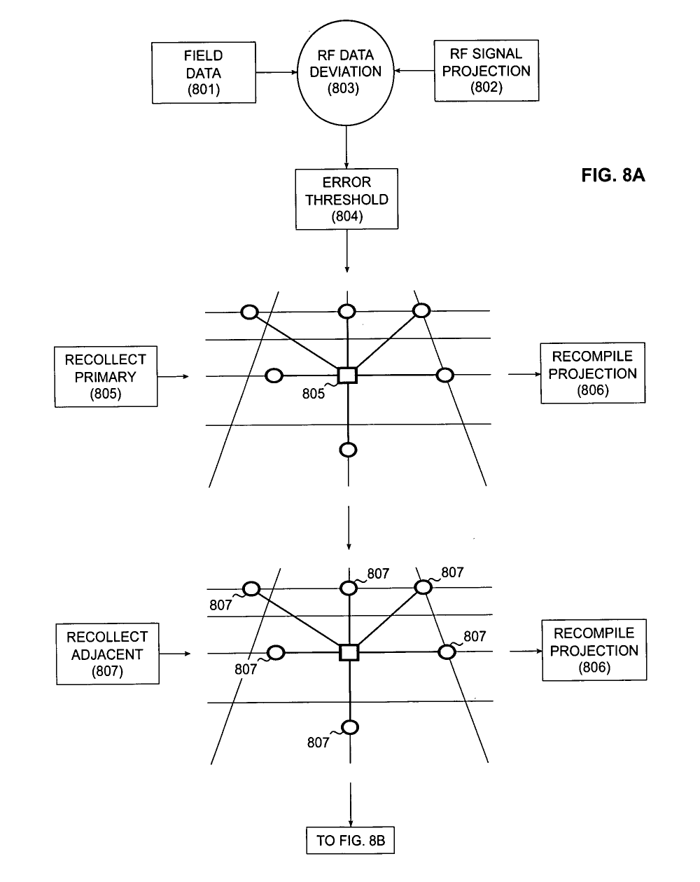

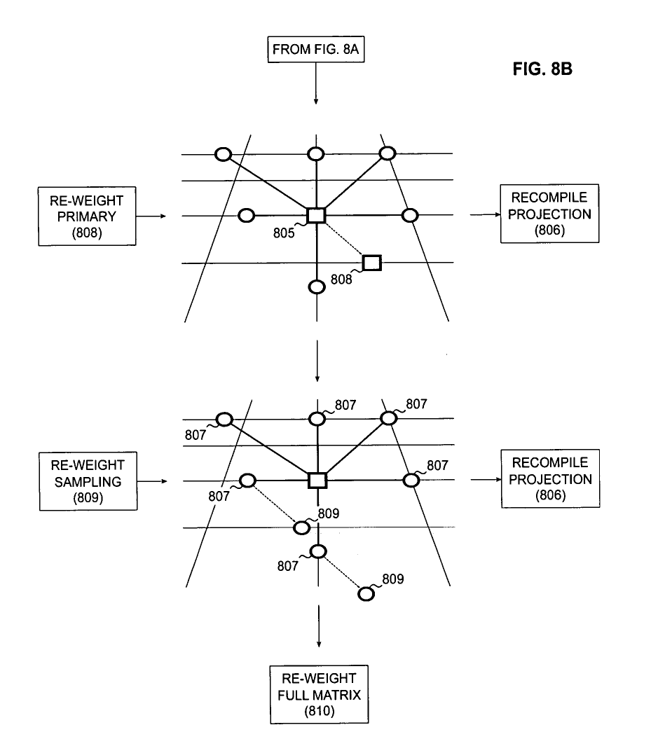

FIG. 8A illustrates this process. RF propagation projection data 802 for a given sub-region of the overall coverage zone (a region covered by a single RF environmental characterization signature) is compared to actual field data 801 collected by handsets and cellular base stations. The deviation 803 between the actual signal quality levels taken in-field and those predicted by projections based on individual RF environmental characterization signatures represents the degree of error contained within said projections. The quantity and variety of actual in-field measurements, as well as the magnitude of predicted vs. actual deviation that constitutes an error are together quantities specific to the accuracy level called for by any individual wireless network application.

When deviation levels 803 exceed the error threshold 804 for a given application, the first step in correcting characterization signature errors is to determine whether the error is a result of anomalous environmental data within the specific signature or due to a more broad-based fault in the data normalization and weighting rules applied to the entire signature matrix. The error correction process begins by recollecting RF environmental data associated with the specific signature 805, from which the insufficiently accurate projection was generated. This process immediately addresses the possibility of spurious data from remote sensing or other signature elements, as well as the chance that massive structural changes in the local environment may have occurred in the time interval between when the RF environmental data was formed into a signature and when that signature was applied to a predictive projection. If this process involving the single offending signature is not successful via a redo of rapid environmental characterization and its associated predictive projection 806, then an examination of neighboring signatures in a localized portion of the signature matrix is done, as errors in the data of signatures used in the fuzzy reconstruction process may be responsible for the observed errors. Signatures and signature sets surrounding the original error prone signature 807 are recompiled with new RF environmental data using either the conventional or rapid characterization method. These newly compiled neighboring signatures are then used to once again reconstruct the erroneous signature and recompile a projection 806.

If reconstruction of both the particular error causing signature 805 and those signatures bordering it in the matrix 807 is not successful in creating predictive projections that match actual handset and base station data taken from the coverage environment 801, then the system must conclude that the errors are not the result of RF environmental data within either the offending signature or its neighboring signatures (i.e. not the result of either spurious elements contained in the original data or massive structural change in the local environment that caused said data to become prematurely obsolete). In this case, error correction is achieved by manipulating the normalization and weighting rules that are applied to the entire matrix.

FIG. 8B illustrates this process. The rogue primary signature 805 is dismantled by removing the effects of normalization and weighting from the raw RF environmental data. Once the original raw data is restored, new normalization and weighting rules are computed, which will allow said raw data to generate a signature that predicts values more closely approximating those seen in actual field measurements. These new rules are then applied to the raw data for the purposes of generating an entirely new signature 808 that replaces the original 805. In turn, this newly generated signature is used to recompile predictive projection 806 of propagation conditions in the selected micro-region, the results of which are compared to the original field measurements, as well as new in-field data acquired from both handsets and base stations 801.

Following confirmation that adjustments in normalization and weighting rules have significantly reduced errors in propagation predictions that rely on the target signature, these newly refined rules are applied to the raw data contained within a sampling of other RF environmental characterization signatures throughout the matrix 807, which constitute a statistically significant representation of the characteristic extremes in local propagation environments. The resulting modified signatures 809 are then used to generate new predictive projection of propagation 806 for relevant micro-regions, and the results compared with automated field survey data 801. If the new normalization and weighting rules effect significant improvement in accuracy across a broad diversity of signatures types, these new rules can be applied to the entire matrix 810. Should they not meet expectations, continual refinement of normalization and weighting is conducted until raw data across the entire sampling yields the best possible propagation projections.

In sum, principles of the present invention allow for a greatly improved ability to analyze, characterize and project the RF propagation dynamics of complex mobile environments. This enhanced ability will be seen by those skilled in the art as a means of significantly increasing the cellularization potential and, therefore, both the coverage reliability and effective bandwidth capacity of cellular-based wireless networks.

The foregoing descriptions of embodiments of the invention have been presented for purposes of illustration and description only. They are not intended to be exhaustive or to limit the invention to the forms disclosed. Many modifications and variations will be apparent to practitioners skilled in the art. Accordingly, the above disclosure is not intended to limit the invention; the scope of the invention is defined by the appended claims.

What is claimed is:

1. A system and method for the characterization of RF propagation parameters in wireless communication networks comprising:
processing circuitry for the collection of RF environmental data;
processing circuitry for the filtering, normalization and weighting of said RF environmental data;
processing circuitry for the creation of RF environmental characterization signatures;
processing circuitry for the integration of said RF environmental characterization signatures into a matrix of RF environmental characterization signatures; and
an RF propagation medium from which said RF environmental data is collected for the purposes of characterization.

2. The processing method of claim 1, comprising the steps of:
collecting a diversity of RF environmental data;
applying filtration, normalization and weighting rules;
compiling filtered, normalized and weighted data into RF environmental characterization signatures; and
placing individual RF environmental signatures into a matrix of many other RF environmental signatures.

3. The processing system of claim 1, wherein said RF propagation medium is free space through which wireless signals are transmitted for the purposes of communication.

4. The processing system of claim 1, wherein said RF environmental data includes a diversity of sources to adequately characterize a coverage environment.

5. The processing system of claim 4, wherein said RF environmental data includes multi-spectral remote sensing imagery of the coverage environment.

6. The processing system of claim 4, wherein said RF environmental data includes signal quality data from handsets and base stations.

7. The processing system of claim 4, wherein said RF environmental data includes field component continuity measurements of the local environment.

8. The processing system of claim 1, wherein said filtering, normalization and weighting of RF environmental data is completed for the purposes of converting raw data into RF environmental characterization signatures.

9. The processing system of claim 8, wherein said filtering, normalization and weighting is controlled by both experimental and process defined rules.

10. The processing system of claim 1, wherein said RF environmental characterization signatures are created to define the propagation dynamics of a given wireless coverage region.

11. The processing system of claim 10, wherein said RF environmental characterization signatures are constructed so as to be compatible with one another for the purposes of comparison.

12. The processing system of claim 1, wherein said RF environmental characterization signatures are integrated into a matrix of other RF environmental signatures representing a broad diversity of RF environmental characteristic extrema.

13. A system and method for the rapid characterization of RF propagation parameters in wireless communications networks comprising:
processing circuitry for the abbreviated collection of RF environmental data;
processing circuitry for the filtering, normalization and weighting of said fractional RF environmental data;
processing circuitry for the creation of a fractional RF environmental characterization signature;
processing circuitry for the comparison of said fractional signature to complete RF environmental characterization signatures in the signature matrix; and
processing circuitry for the reconstruction of said fractional signature into a complete RF environmental characterization signature.

14. The processing method of claim 13, comprising the steps of:
collecting severely abbreviated RF environmental data;
applying filtering, normalization and weighting rules to the abbreviated data;
generating a fractional RF environmental characterization signature from the abbreviated data;
determining the relative position of the fractional RF environmental characterization signature among the continuum of RF environmental types contained within the signature matrix; and
using the comparison of the fraction signature to complete RF environmental characterization signatures for the purposes of reconstructing said fractional signature.

15. The processing system of claim 13, wherein said abbreviated RF environmental data is the minimum amount required to create a viable fractional RF environmental characterization signature.

16. The processing system of claim 13, wherein said abbreviated RF environmental data is derived from remote sensing.

17. The processing system of claim 13, wherein said fractional RF environmental characterization signature is compatible with complete RF environmental characterization signatures for the purposes of comparative analysis.

18. The processing system of claim 13, wherein said reconstruction of said fractional signature is accomplished through the use of fuzzy logic processes.

19. A system and method for the prediction of RF propagation parameters in wireless communication networks comprising:
processing circuitry for the collection of limited RF environmental data;
processing circuitry for the correlation of limited RF environmental data with existing RF environmental characterization signatures;
processing circuitry for the projection of localized RF propagation parameters using RF environmental characterization signatures; and
processing circuitry for the correction of errors and the refinement of both characterization and prediction accuracy.

20. The processing method of claim 19, comprising the steps of:
collecting limited RF environmental data;
correlating said RF environmental data with complete RF environmental characterization signatures already contained within the signature matrix;
using relevant RF environmental characterization signatures to create predictive projections of RF dynamics in localized coverage environments; and
deploying a series of error detection, correction and refinement techniques for the purposes of improving the accuracy of said projections.

21. The processing system of claim 19, wherein said RF environmental data is collected for the purposes of correlating the propagation dynamics of a local environment with those contained in existing RF environmental characterization signatures.

22. The processing system of claim 19, wherein said projection of localized RF propagation parameters include two and three-dimensional graphic representations of signal attributes within a given geographic region.

23. The processing system of claim 19, wherein said error detection, correction and refinement techniques are used to locate and direct the improvement of raw RF environmental data contained within RF environmental classification signatures.

24. The processing system of claim 19, wherein said error detection, correction and refinement techniques are used to evaluate and direct the reconfiguration of the filtration, normalization and weighting rules applied to raw RF environmental data contained within RF environmental classification signatures.
